(19) United States
(12) Patent Application Publication
(10) Pub. No.: US 2013/0290224 A1
(43) Pub. Date: Oct. 31, 2013

(54) System or Solution Index Fault - Assessment, Identification, Baseline, and Alarm Feature

(71) Applicant: Joseph Michael Clarke, Cary, NC (US)

(72) Inventors: Scott Crowns, Campbell, CA (US); Joseph Michael Clarke, Cary, NC (US)

(73) Assignee: Cisco Technology, Inc., San Jose, CA (US)

(21) Appl. No.: 13/459,941

(22) Filed: Apr. 30, 2012

(51) Int. Cl. G06N 99/00

(52) U.S. Cl. CPC G06N 99/005
USPC 706/12

(57) ABSTRACT

A system may be assessed, based on support engineer knowledge, to identify specific, predictive, index fault indicators. The identified fault indicators may be fed into an embedded automation system on a network device, which is used to baseline the fault indicators, and then subsequently provide alerts when problems begin, so that corrective action may be taken.

### BACKGROUND

Complex networking systems can often experience cascading and other serious problems. Problems may originate more commonly with new systems, new software deployments, and when significant changes are made to the networks. There exists a need for detecting major network impacting events coming from within these systems.

### BRIEF DESCRIPTION OF THE DRAWINGS

The accompanying drawings, which are incorporated in and constitute a part of this disclosure, illustrate various embodiments. In the drawings:

FIG. 1 is an illustration of an operating environment for embodiments described herein;

FIG. 2 is a flow chart of embodiments of the disclosure;

FIG. 3 is a flow chart of embodiments of the disclosure;

FIG. 4 is a block diagram of a network computing device.

### DESCRIPTION OF EXAMPLE EMBODIMENTS OVERVIEW

Consistent with embodiments of the present disclosure, systems and methods are disclosed for network event detection and assessment. A system may be assessed, based on support engineer knowledge, to identify specific, predictive, index fault indicators. The identified fault indicators may be fed into an embedded automation system on a network device, which is used to baseline the fault indicators, and then subsequently provide alerts when problems begin, so that corrective action may be taken.

It is to be understood that both the foregoing general description and the following detailed description are examples and explanatory only, and should not be considered to restrict the application's scope, as described and claimed. Further, features and/or variations may be provided in addition to those set forth herein. For example, embodiments of the present disclosure may be directed to various feature combinations and sub-combinations described in the detailed description.

### DETAILED DESCRIPTION

The following detailed description refers to the accompanying drawings. Wherever possible, the same reference numbers are used in the drawings and the following description to refer to the same or similar elements. While embodiments of this disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Embodiments of the present disclosure assess systems or solutions to find major areas of vulnerability or area where bellwether fault indicators may be present to give early warning of cascading or other catastrophic customer problems. For example, embodiments herein describe how to identify and record these bellwether fault indicators through technical center case analysis.

In some embodiments, baseline measurements may be taken in this manner and stored for later comparison. Priorities and thresholds may then be established using these baselines in combination with the customer business and operational needs.

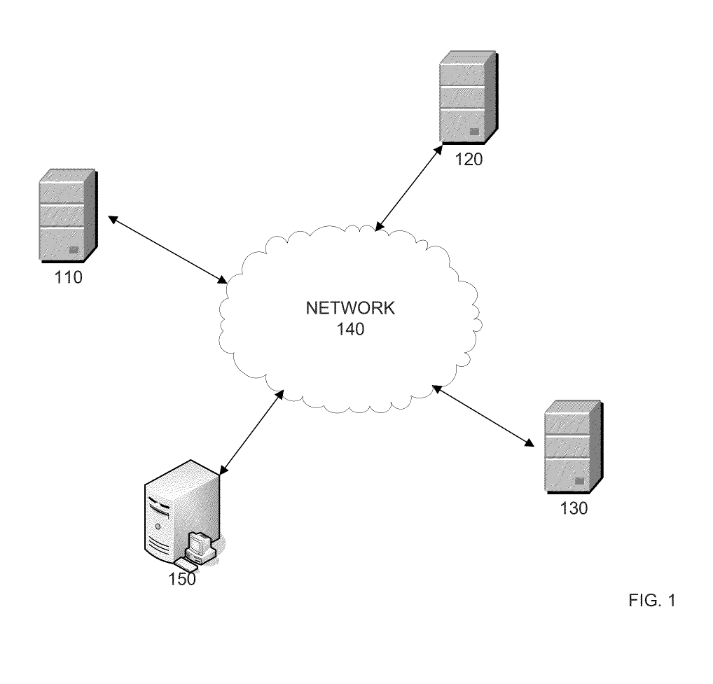

FIG. 1 illustrates an operating environment for embodiments of the present disclosure. Any number of network devices such as network devices 110, 120, and 130 may be in communication with one another across a communications network 140. The network devices may further be in communication with a centralized Network Management System 150.

When a system is operational, the number and the frequency of recorded fault indicators may be compared to baseline measurements. If the baseline values have been significantly exceeded, an alert may be raised by the system. This may result in a trouble ticket being opened. In some embodiments, automated actions may be employed to attempt to remedy the situation.

Embodiments of the present disclosure use referred technical advisor cases for a system (this could also be done in a system lab, with senior technical advisor engineers, or for systems that have not yet deployed) to identify precursors of major, customer impacting, problems unique to a system. Next, these fault indicators may be included, identified, recorded, and compared against baselines of normal function. These indicators may be collected from a given customer network and then the network may be monitored for alerts when indicators are significantly in excess of baseline levels.

The collection of information to build the baseline, as well as the monitoring for threshold violations can be done using automation embedded into the devices. Embedded automation may collect syslogs over time, as well as periodically run system-based diagnostic commands to parse and store output. The number of system-related syslogs may be tracked as well as typical values of command line interface (“CLI”) command outputs (e.g. averages for integral values, repeated values for statuses, etc.). These values may become the baseline values.

The established baseline may be augmented by input from a centralized NMS. The centralized NMS can receive prioritization data from an authoritative backend based on learned data from previously reported problems.

Once the baseline is constructed, the network device may switch to a monitor mode. Any excessive violations of the determined baseline may result in the device notifying a centralized Network Management System (NMS), individual user, a trouble ticketing system, etc. about potential issues. If required, the baseline algorithm can be re-run on the device as needed. As new data is learned from other sources, or if the network conditions change, the baseline data stored in devices may also need to change. The centralized NMS can trigger the recalculation, or the recalculation can be triggered manually.

Embodiments of the present disclosure avoid having to try to proactively anticipate every problem from software defects, third party products or user error. Monitoring those areas where such problems begin showing up, well before major customer problems are encountered provides a mush smoother customer experience.

Embodiments of the present disclosure provide processes for analyzing technical advisor referred cases to develop Bellwether events and index fault indicators (“IFI”), as well as their relative impacts and priorities. Technical advisor referred cases may be analyzed to find most common problem scenarios reported. Note is made of diagnostic commands, debugs or other methods used to troubleshoot the problem at the back end. Combinations of devices with inter-device problems may be noted.

Special emphasis may also be placed on problems that fall in between two different technical advisor team areas of expertise. In this scenario, expertise of technical advisor engineers for each product may be combined to quickly eliminate one product or the other from consideration.

Diagnostic information gathered may be compared against fault isolation. Best methods for fault identification may be recorded. Detection methods, fault indicators, remediation steps, final resolutions and any additional methods used to verify the fix may be correlated with one another.

Common problem scenarios may be analyzed in terms of impact on customer sentiment, customer business value and essential customer business processes. An additional dimension of time to resolve as well as cases that move in between different technical advisor groups, due to challenges in issue identification or resolution may be identified. Problems requiring escalation to a particular business unit that owns a product may also be identified. Gathering IFI in these situations may speed response time to technical advisor escalations.

Embodiments of the present disclosure allow for a matrix of information to be created. Information in the matrix may include, but is not limited to: 1) Customer reported symptom; 2) cause (if known); 3) high level system response (may be one or more discrete malfunctions)|low level system response (may also include reactive actions taken by the system automatically) (may be one or more of multiple)|Impact of system response on customer|Impact of system response on the overall system

Embodiments of the present disclosure may employ test data gathered from both customer equipment and through interaction with third party equipment to establish baseline values. The information may be gathered and calculated prior to customer deployment, with network profile data, customer market segment information, business type, deployment size, etc, combined with actual customer network baselines, information gleaned from previous referred technical advisor cases and variable customer values, in terms of thresholds for events and their relative priorities.

The criteria used for automation of technical advisor case analysis to find bellwether events and index indicators of fault may include one or more of programmable indicators, priorities and thresholds, and customer defined values. A central NMS that has bi-directional communication may have embedded automation on the component devices. The central NMS can communicate values to the embedded component level automation, based on historical network baselines, customer, business unit, or technical advisor priorities and previously discovered fault indicators, as well as previously developed “average” network traffic profiles.

The embedded automation on the component devices can run diagnostic commands, perform debugs or take other CLI or Graphical User Interface (GUI) based actions and then communicate these results back to the central NMS. This allows the system to learn and adapt, be distributed, take automated or directed action and also be tuned to customer preference, technical advisor experiences and/or business unit priorities.

Ultimately, customers and partners can also contribute to the embedded device functionality by creating their own troubleshooting and monitoring applications, which would then communicate with and potentially be controlled by the central NMS. Applications may be subsequently developed based on the troubleshooting experience with the products.

In some embodiments baselines and thresholds may be established using a combination of defined performance parameters, information captured by the embedded component level automation in situations involving network failure and customer preference (what level of capability reserve does a customer want to be always available and is willing to pay for).

The process may be automated in code. There are two areas of implementation for the solution in code, prior to first customer deployment and post customer deployment.

Prior to first customer deployment, using network services, such as policy-based access control or systems designed to measure, report, and reduce energy consumption across an entire infrastructure, bellwether events and associated Index Fault Indicators (IFI) may be catalogued based on their CPU impact along multiple dimensions. CPU impact may be used as the first assessment standard, due to the strong correlation between high CPU impact events and catastrophic customer network outages.

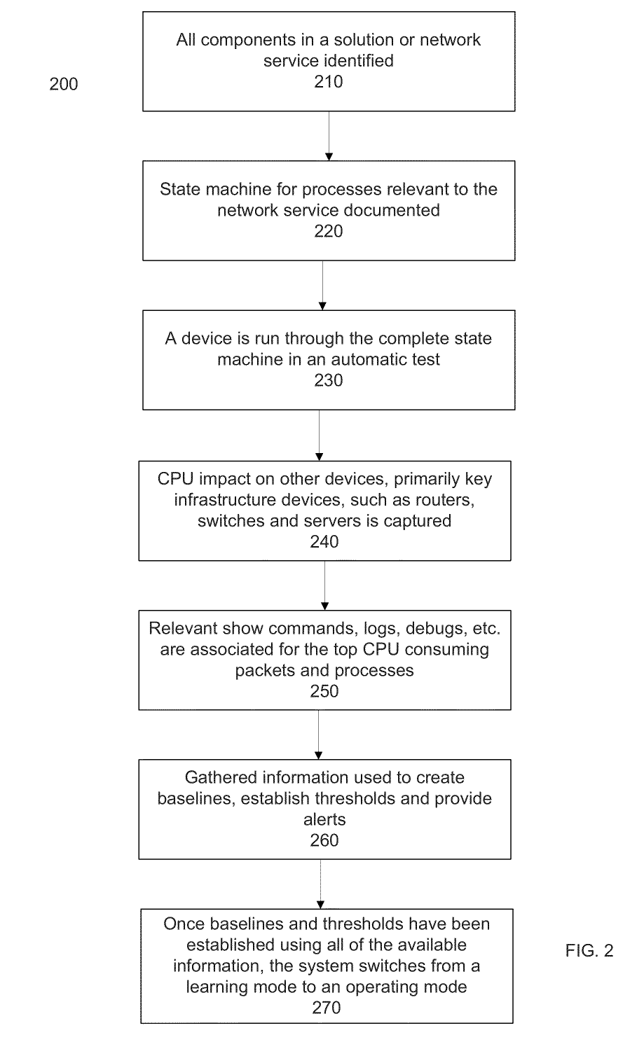

To develop IFI, the following algorithm is implemented in automated testing and capture code. The code may reside on an external tool and not within the product itself. CPU impact of bellwether events is described in conjunction with the flow chart illustrated in FIG. 2.

Method 200 may start at step 210 where all components in a solution or network service are identified. Method 200 may then proceed to step 220. At step 220, the complete state machine for processes relevant to the network service may be documented. For example, with policy-based access control, the full state machine for port level authentication of a PC or phone may be documented.

Subsequently, method 200 may proceed to step 230. At step 230, the device is run through the complete state machine in an automatic test. Upon completion of initial testing, method 200 may proceed to step 240 where the CPU impact on other devices, primarily key infrastructure devices, such as routers, switches and servers, may be captured in terms of consumption of CPU resources per control packet generated for each step in the state machine.

CPU impact may be captured in the following ways: 1) single packet; 2) high packet rate over compressed time interval; 3) high packet rate combined with typical network traffic profiles; 4) high packet rate combined with multiple network services and various network traffic profiles. Network traffic profiles may be created based on various categorizations of customer organizations, such as large enterprise, medium service provider, etc. Traffic profiles may be based on number of PCs, number of phones, data rate, essential business processes, number of remote locations, etc.

In some embodiments, a sniffer may capture general traffic patterns, from “typical” representatives in each network traffic profile. These obtained network traffic profiles may be assembled in a library for use in a standardized testing and for benchmarking.

Method 200 may then proceed to step 250. At step 250, relevant diagnostic commands, logs, debugs, etc. are associated for the top CPU consuming packets and processes. Next, at step 260 the gathered information may then be used to create baselines, establish thresholds and provide alerts. This functionality may now be coded into the system itself and the associated component devices.

Method 200 may then be repeated for other assessment standards which have high correlation to catastrophic customer network impacting events, such as mass state transitions effecting customer or end user business value. An example would be mass port transitions with policy-based access control, rendering large numbers of users unable to access their own network, critical devices or essential services. A similar example would be wide spread shutting down of power to end user devices during normal business hours.

In embodiments of the present disclosure, method 200 may further proceed to step 270. At step 270, once the baselines and thresholds have been established using all of the available information, the system may switch from a learning mode to an operating mode. When in operating mode, the system employs the established baselines as a template to be used for measuring current operating conditions.

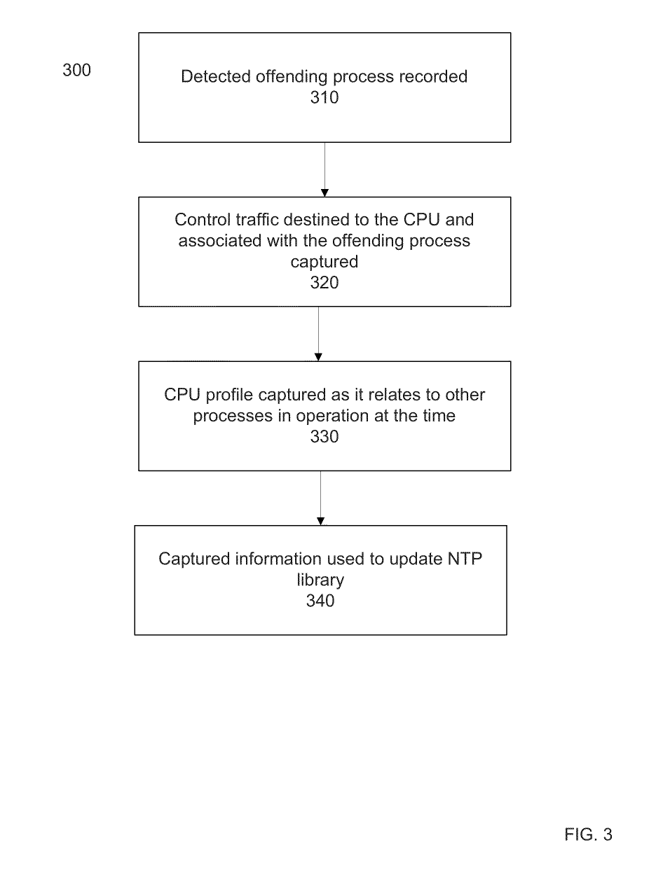

Once the system is deployed to a particular customer, automated code may be created on the system itself and within key component devices that activates when high consumption of CPU resources is detected. This could occur on an individual process level and well below a critical level of consumption for overall device operation. When high CPU consumption is detected, method 300, as illustrated in FIG. 3 may be executed.

Method 300 may begin at step 310 where a detected offending process may be recorded. When an offending process is detected and recorded, method 300 may proceed to step 320. At step 320, control traffic destined to the CPU and associated with the offending process may be captured. In some embodiments, this would not be all traffic, but a representative sample of the traffic.

Method 300 may proceed to step 330. At step 330, the CPU profile is captured as it relates to other processes in operation at the time. Furthermore, an embedded packet sniffer may be activated to capture a cross section of network traffic at this time and update any newly identified IFIs.

If during the high CPU event other previously identified IFIs are present, they may be captured and stored with the new information for analysis. Method 300 may continue to step 340 where captured information is used to update the network traffic profile library used for automated testing during the pre-customer first deployment activities for subsequent releases. Furthermore, the IFIs may now be incorporated into embedded automation policies, which the customer can download or be provided in other reasonable manners.

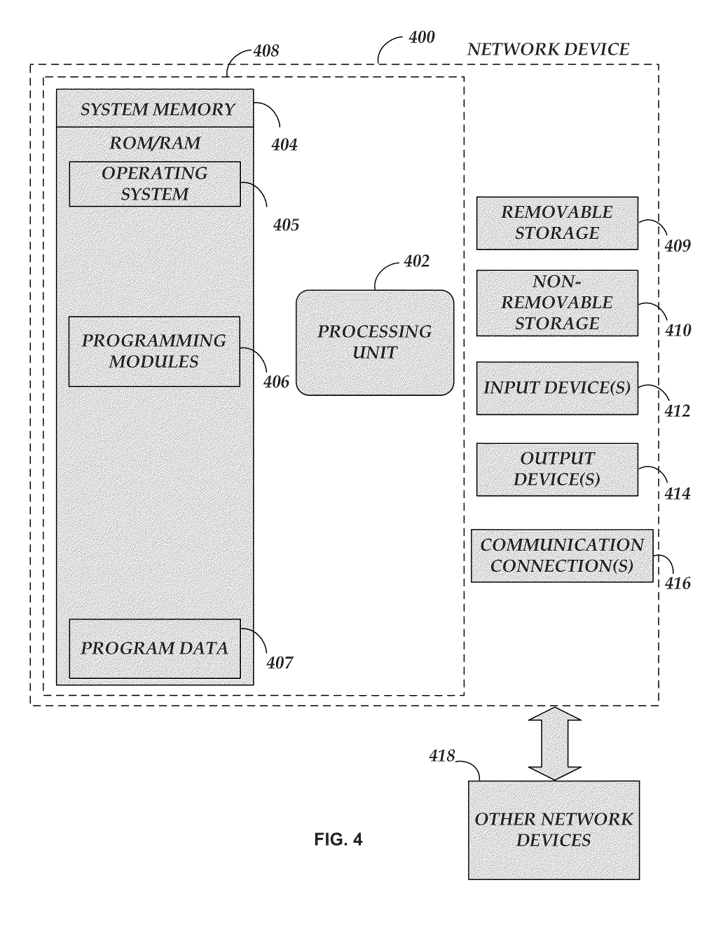

FIG. 4 is a block diagram of a system including network device 400. Consistent with embodiments of the present disclosure, the aforementioned memory storage and processing unit may be implemented in a network device, such as network device 400 of FIG. 4. Any suitable combination of hardware, software, or firmware may be used to implement the memory storage and processing unit. For example, the memory storage and processing unit may be implemented with network device 400 or any of other network devices 418, in combination with network device 400. The aforementioned system, device, and processors are examples and other systems, devices, and processors may comprise the aforementioned memory storage and processing unit, consistent with embodiments of the present disclosure.

With reference to FIG. 4, a system consistent with embodiments of the present disclosure may include a network device, such as network device 400. In a basic configuration, network device 400 may include at least one processing unit 402, a secure processing unit for decryption 420, and a system memory 404. Depending on the configuration and type of network device, system memory 404 may comprise, but is not limited to, volatile (e.g., random access memory (RAM)), non-volatile (e.g., read-only memory (ROM)), flash memory, or any combination. System memory 404 may include operating system 405, one or more programming modules 406, and may include program data 407. Operating system 405, for example, may be suitable for controlling network device 400's operation. Furthermore, embodiments of the present disclosure may be practiced in conjunction with a graphics library, other operating systems, or any other application program and is not limited to any particular application or system. This basic configuration is illustrated in FIG. 4 by those components within a dashed line 408.

Network device 400 may have additional features or functionality. For example, network device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by network device 400. Any such computer storage media may be part of device 400. Network device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

Network device 400 may also contain a communication connection 416 that may allow device 400 to communicate with other network devices 418, such as over a network in a distributed network environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402 or secure processing unit for decryption 420, programming modules 406 may perform processes including, for example, one or more method 200 and 300's stages as described above. The aforementioned process is an example; processing unit 402 and secure processing unit for decryption 420 may perform other processes.

Generally, consistent with per-subscriber stream management according to embodiments of this invention, program modules may include routines, programs, components, data structures, and other types of structures that may perform particular tasks or that may implement particular abstract data types. Moreover, embodiments may be practiced with other computer system configurations, including hand-held devices, multiprocessor systems, microprocessor-based or programmable consumer electronics, minicomputers, mainframe computers, and the like. Embodiments of the present disclosure may also be practiced in distributed network environments where tasks are performed by remote processing devices that are linked through a communications network. In a distributed network environment, program modules may be located in both local and remote memory storage devices.

Furthermore, embodiments of the present disclosure may be practiced in an electrical circuit comprising discrete electronic elements, packaged or integrated electronic chips containing logic gates, a circuit utilizing a microprocessor, or on a single chip containing electronic elements or microprocessors. Embodiments may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present disclosure, for example, may be implemented as a computer process (method), a network system, or as an article of manufacture, such as a computer program product or computer readable media. The computer program product may be a computer storage media readable by a computer system and encoding a computer program of instructions for executing a computer process. The computer program product may also be a propagated signal on a carrier readable by a network system and encoding a computer program of instructions for executing a computer process. Accordingly, aspects may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EEPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of per-subscriber stream management. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the present disclosure have been described, other embodiments may exist. Furthermore, although embodiments have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the present disclosure.

What is claimed is:

1. A method comprising:
identifying a plurality of components in a network service or solution;
documenting a complete state machine for processes relevant to the network service or solution;
running at least one of the plurality of components through the complete state machine in an automatic test;
capturing the impact on one or more of the remainder of the plurality of components;
using captured impact information to create one or more baselines and establish one or more thresholds; and
providing alerts when a threshold is violated.

2. The method of claim 1, further comprising documenting the full state machine for port level authentication of one of a: personal computer or phone.

3. The method of claim 1, wherein the one or more of the remainder of the plurality of components includes primarily key infrastructure devices.

4. The method of claim 1, further comprising capturing consumption of CPU resources per control packet generated for each step in the state machine.

5. The method of claim 4, wherein consumption of CPU resources is captured by one of: single packet measurement, high packet rate over compressed time interval measurement, high packet rate combined with typical network traffic profiles; high packet rate combined with multiple network services.

6. The method of claim 1, further comprising
creating a network profile based on categorizations of customer organizations and the number of components.

7. The method of claim 6, further comprising:
employing a sniffer to capture general traffic patterns from representatives in the network profile.

8. The method of claim 7, further comprising:
assembling a plurality of created network profiles in a library.

9. The method of claim 8, further comprising performing standardized testing for benchmarking on the plurality of created network profiles.

10. The method of claim 1, associating relevant logs for identified top CPU consuming packets and processes.

11. The method of claim 1, wherein the network service is a mass port transition.

12. The method of claim 1, further comprising:
switching from a learning mode to an operating mode;
measuring current operating conditions; and
comparing the current operating conditions to one or more established baselines.

13. The method of claim 1, further comprising creating automated code that activates when high consumption of CPU resources is detected.

14. A method comprising:
detecting CPU usage above an established threshold;
recording identification of an offending process causing the CPU usage;
capturing associating control traffic destined to the CPU with the offending process;
capturing a CPU profile as it relates to processes other than the offending process in operation; and
updating a network profile library with the captured information is used to update a network traffic profile library.

15. The method of claim 14, wherein the captured traffic, is a representative sample of the offending process traffic.

16. The method of claim 14, further comprising activating an embedded packet sniffer to capture a cross section of network traffic.

17. The method of claim 16, further comprising updating any newly identified index fault indicators.

18. The method of claim 17, further comprising configuring a processor to assess the readiness of the network to support one of: a specific solution and a whole offer overlay.

19. The method of claim 14, further comprising using the library for automated testing.

20. An apparatus comprising:
a network profile library comprising determined index fault indicators associated with network processes; and
a processor, wherein the processor is configured to:
identify predictive index fault indicators;
record identification of an process offending one or more predictive index fault indicators in the network profile library; and
automatically provide alerts based on detection of an offending process.
